(19) United States
(12) Patent Application Publication
(10) Pub. No.: US 2026/0170815 A1
(43) Pub. Date: Jun. 18, 2026

(54) APPARATUS AND METHOD FOR GESTURE RECOGNITION STABILIZATION

(71) Applicant: CANON U.S.A., INC., MELVILLE, NY (US)

(72) Inventor: Bradley Scott Denney, Irvine, CA (US)

(21) Appl. No.: 18/720,969

(22) PCT Filed: Dec. 19, 2022
(86) PCT No.: PCT/US2022/081944

§ 371 Date: Jun. 17, 2024

Related U.S. Application Data
(60) Provisional application No. 63/291,691, filed on Dec. 20, 2021.

(51) Int. Cl. G06V 10/82; G06F 3/04883; G06V 10/46

(52) U.S. Cl. CPC G06V 10/82; G06F 3/04883; G06V 10/462

(57) ABSTRACT

An apparatus and method is provided that generates a hand model for use in training a gesture recognition model that recognizes a hand gesture in a video data stream. The apparatus includes one or more memories storing instructions and one or more processors that, upon execution of the instructions stored in memory, are configured identify digit vectors of a hand captured in video data by an image capture apparatus, normalize each identified digit, generate a feature matrix by determining a feature associated with each normalized identified digit with respect to each other normalized identified digits, flatten the generated feature matrix into a feature vector representing a state of the hand skeleton, and train a machine learning model based on the flattened feature matrix.

### CROSS REFERENCE TO RELATED APPLICATIONS

This application claims priority from U.S. Provisional patent Application Ser. No. 63/291,691 filed on Dec. 20, 2021, the entirety of which is incorporated herein by reference.

### BACKGROUND

### Field

The present disclosure relates to image processing and, more specifically, the detecting gestures performed in captured images.

### Description of the Related Art

It has been desirable to use non-contact input sources to perform control tasks for various computing systems including laptops, smartphones and the like. To achieve this objective devices having an image capture apparatus are able to capture images and identify body parts of users in the captured image. When attempting to detect a hand gesture in a captured image, the reliability with which these gestures are identified from the image being captured is less than desirable and often yield incorrect false positive and false negative indications of the gesture being detected. A system and method according the present disclosure remedies the drawback associated with gesture detection processing.

### SUMMARY

According to the disclosure an apparatus and method is provided that generates a hand model for use in training a gesture recognition model that recognizes a hand gesture in a video data stream. The apparatus includes one or more memories storing instructions and one or more processors that, upon execution of the instructions stored in memory, are configured to identify digit vectors of a hand captured in video data by a an image capture apparatus, normalize each identified digit, generate a feature matrix by determining a feature associated with each normalized identified digit with respect to each other normalized identified digits, flatten the generated feature matrix into a feature vector representing a state of the hand skeleton, and train a machine learning model based on the flattened feature matrix.

According to an embodiment, the machine learning model includes an input layer that receives an input having a size equal to a size of the flattened generated feature matrix, a first dense layer having a first predetermined number of nodes with a first weighted matrix and a first length bias, a non-linear layer including a predetermined number of activation functions, a second dense layer having a second predetermined number of nodes with a second weighted matrix and a second length bias, and a non-linear softmax layer, wherein the non-linear softmax layer outputs a confidence score identifying that a hand position corresponding to a hand in the captured video data is performing a predetermined gesture.

According to another embodiment, execution of the instructions further configures the one or more processors to generate the feature matrix by determining a dot product of each identified digit with respect to all other identified digits to generate diagonal feature information representative of the dot product of each normalized digit with itself and modifying the diagonal feature information to generate an enhanced feature vector using a predetermined feature modifier. In one embodiment, the feature modifier normalizes a length of a respective digit based on a reference digit length and the reference digit length includes one or more of a minimum digit length, a maximum digit length, a median digit length and mean digit length. In another embodiment, the feature modifier calculates a mid-digit point distance relative to a predetermined joint reference point that is normalized by a reference digit. In yet another embodiment, the feature modifier calculates an angle of a digit relative to a fixed vector in a predetermined direction to determined an orientation of a hand in the video data.

In a further embodiment, execution of the instructions further configures the one or more processors to receive video data from an image capture device and use the trained machine learning model to detect performance of a gesture in the received video data.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a hand detector module.

FIG. 2 illustrates an image processing algorithm according to the present disclosure.

FIG. 3 illustrates an image processing algorithm according to the present disclosure.

FIG. 4 illustrates the hardware configuration according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

According the present disclosure, a gesture recognition system that uses a deep learning hand skeleton model to recognize static hand gestures is described herein. The present disclosure describes a hand skeleton detector that obtains information about the skeletal position of a hand in a captured image. A hand feature vector generation module performs processing to detect, from the skeleton detection results, a feature of a hand within the captured image data. The detected feature of the hand represents it's position in the particular frame and, based on that, can be used to predict whether the current state of the hand is performing one or more gestures that may be used to control an operation of a computing system. The hand feature is provided as a hand feature vector as an input to a static gesture learning module that has been trained according to images of hands that are in one of the various positions associated with a particular gesture. A corresponding gesture inference module performs a first classification of the state of the hand based on the hand feature vector to provide a first likelihood value that the hand is performing the gesture or not performing the gesture. The first likelihood value is provided as in input to a final gesture determination module which outputs a final prediction that the hand in the captured image is performing the gesture or not performing the gesture based on the current hand gesture inference module results and the prior final gesture determination module results. Thus, the described gesture detection processing advantageously uses the transition information that exists between a current prediction and previous final prediction to increase the confidence of the system in identifying whether or not a person in the image is intending to (or actually performing) a gesture that can be used to control a computing system.

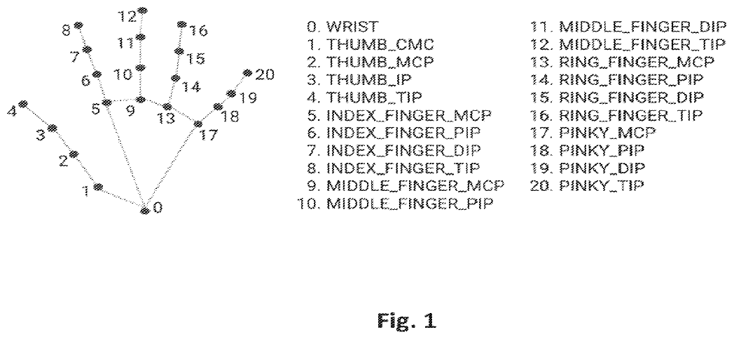

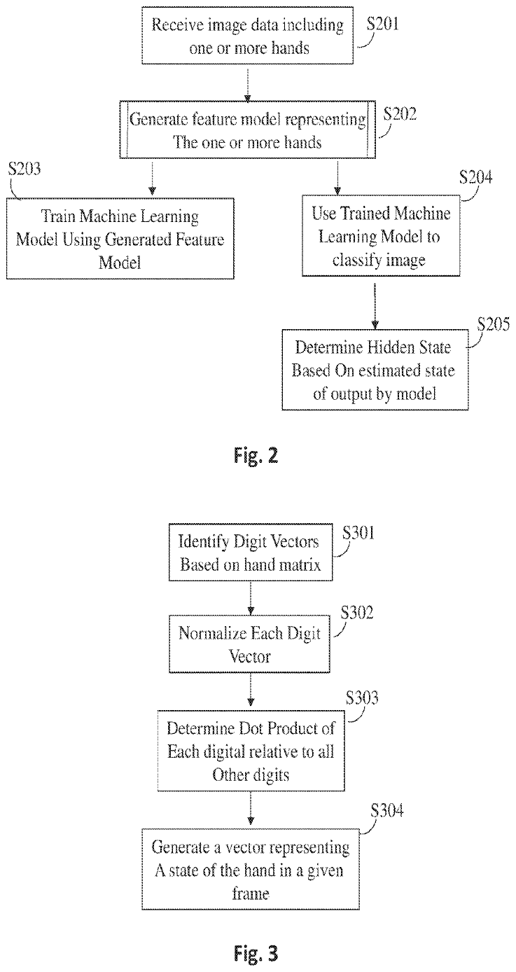

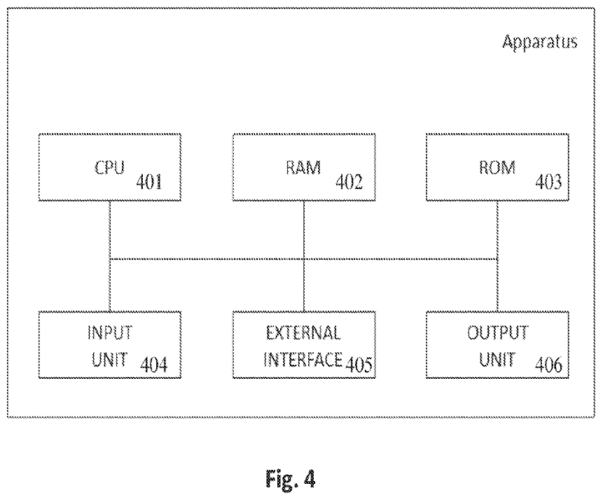

FIG. 2 illustrates a flow diagram of the algorithm that is executed by one or more information processing apparatuses as shown in FIG. 4 to obtain the final determination as to whether a gesture is being performed. At S201 a hand skeleton detector module is provided and uses captured image data to detect the presence and position of one or more hands in an image or sequence of images. The hand skeleton detector estimates the 3D joint locations using one or more available hand model libraries. An exemplary embodiment is shown in FIG. 1 which illustrates detected hand joint locations for a hand. Each of the 21 points have a corresponding (x,y,z) coordinate estimate in normalized image coordinates when these are determined from a captured image. In this embodiment, a hand detection module returns X which is a 21×3 matrix of joint coordinates. This is merely one exemplary embodiment of a hand matrix that can be used in accordance with the principles of this disclosure. The generated hand matrix, as shown in S201 is provided as an input to a hand feature module S202. The hand feature modules uses the input hand matrix data to determine the feature of the hand in a given frame. The hand features determined in S202 include the position and orientation of the skeletal structure of the hand in the capture image data. In real-time video this is performed on a frame-by-frame basis. The processing performed by the hand feature module is described in FIG. 3.

In S301, the matrix X output at S201 is converted to a hand feature vector by identifying digit vectors associated with the hand in the image data. A digit vector is the vector from one joint to the next in the graph starting at the base of the palm and extending to each fingertip starting with the thumb and ending with the small finger. The first digit is the vector V_{0,1}=X[1,:]-X[0,:] and the digits for the fingers as are follows:
i. Thumb digits: V_{0,1}, V_{1,2}, V_{2,3}, V_{3,4}
ii. Index finger digits: V_{0,5}, V_{5,6}, V_{6,7}, V_{7,8}
iii. Middle finger digits: V_{0,9}, V_{9,10}, V_{10,11}, V_{11,12}
iv. Ring finger digits: V_{0,13}, V_{13,14}, V_{14,15}, V_{15,16}
v. Small finger digits: V_{0,17}, V_{17,18}, V_{18,19}, V_{19,20}

The result is this identification is V which is a 20×3 matrix where each row is a digit vector which is then normalized in S302. The normalization processing is performed on each digit vector to produce H_{i,j}=V_{i,j}/V_{i,j}| which is a unit vector. The normalization of the joints produces digits that are less dependent on the size and bone length of the individual being imaged which results in matrix H is a 20×3 matrix representing the normalized digits.

In S303, the algorithm determines the dot product of each digit with every other digit. The dot product of each digit with all others is the outer product M=H H^{T}. This is a 20×20 matrix. Since the diagonal elements represent the dot product of each normalized digit with itself, the diagonal elements are all of value of 1, while the non-diagonal elements are all in the range [−1, 1]. Since the dot product of two normal vectors is equivalent to the cosine of the angle between the two vectors, some embodiments use an inverse cosine to convert the values of the H matrix to an angle from 0 to π. Some embodiments modify the diagonal term to further enhance the feature vector. In one embodiment, the enhanced vector represents the digit length normalized by a reference digit length such as minimum, maximum, median, mean digit length. This provides an indication that the proportions of the hand indicate that what is being detected is an actual hand and advantageously prevents misidentification of other objects as a hand. Thus, this can be processed to provide additional evidence indicating that the hand detection is successful.

In another embodiment, the enhanced feature vector includes mid-digit point distance to reference joint point (such as palm base) normalized by a reference digit length. This modification advantageously looks at both relative angles and allows for a determination as to how close each point is to a predetermined reference point. In one embodiment, the predetermined reference point is a point substantially located at the palm of the hand such as a center point of the palm of the hand. This advantageously enables better identification of the proximity of bones to one another which improves the accuracy of identifying hand position.

In a further embodiment, the enhanced feature vector includes angle information of digit relative to a fixed vector such as a vertical or horizontal facing vector to capture hand orientation in the image. This advantageously enables the identification of the hand relative to the hand position. Without this enhancement, hand position detection would be invariant to rotation. As such, this improves the ability to understand a hand (and the associated gesture it is making) is in a particular orientation. Some embodiments may enhance the matrix by using a combination of these enhancements through modifying the diagonal or by adding rows or columns on the 20×20 matrix. For example 3 of the aforementioned enhancements may be added by adding 3 additional columns to make a 20×23 size enhanced dot product matrix.

Thereafter, in embodiments modifying the diagonal, the generated dot product matrix is flattened to a length 400 vector representing the state of the hand skeleton. Turning back to FIG. 2, the output of the flattened hand matric can be provided as an input for training a machine learning model as in S203 in a case where the model has not be generated. Alternatively, and in exemplary operation, the flattened feature vector that is captured during real-time image capture is provided as input to the trained machine learning model that has been trained, as will be discussed below, to classify (or inferencing) whether or not the hand detected in the capture image is performing a gesture, or not, based on the determined feature vector.

The model that will either be trained using the flattened feature vector or that will provide an inference as to the state of the hand in a captured image is as follows. In particular, the model is a deep learning hand gesture model which uses a multi-dense-layer neural network. As an example, a learning and inference model for 5 gesture classes (4 gestures+1 “none” gesture) includes an input layer taking an input vector of predetermined length based on the length of the flattened vector. In this embodiment, the vector length is 400. The model further includes a dense layer of 100 neurons (a 400×100 weight matrix plus a length 100 bias) and a non-linear layer consisting of rectified linear unit activation functions. The rectified linear activation unit is merely is one type of activation function that may be used in the present algorithm and should not be considered as limiting. A dense layer of 5 neurons (a 50×5 weight matrix plus a length 5 bias) is provided and a non-linear layer consisting of a softmax layer from which the inference as to the state of the hand is output.

In S203, when performing the training process, the model (network) is trained using images where users in the image are performing the different gestures to be detected and also images where none of the gestures are being performed to represent the “none” class which typically represents views of the hand not performing gestures. Each of the training images used to train the model in S203 undergoes the processing in S201 and S202 which generates the flattened feature model so that the model may learn to infer which if any gestures are performed. In one embodiment the system was trained with an optimizer such as the Adam optimizer, with a learning rate of 0.0001 for 1000 epochs and a batch size of 512 images.

After successful training and in the case where the trained model is tasked with inferring (S204) whether a hand feature vector corresponding to a captured image represents one or more of the gestures or no gesture, the network outputs a likelihood score for each gesture category between zero and 1 where the total sum of all class scores is 1. Thus, the score may be interpreted as a confidence score or a probability of the hand movement in the capture image data is associated with one of the identified gestures or none of them. For example, the gesture category having the highest score indicates a likelihood that that gesture has been detected. This represents the current state of the system.

While this gesture detection processing provides a degree confidence, the final gesture detection module configured to detect the hidden state of the system based on the inference supplied thereto is performed in S205. While the static gesture inference model may estimate the state, it can be considered as merely providing evidence for the true states. In this sense, the current state of the system (the current gesture) depends on the previous state of the system (at the recent previous observation time step) and the new evidence. The final gesture detection module uses a a Hidden Markov Model to derive the actual state of the system (e.g. current gesture) based on the current state and recently determined states. Since this is a causal system, the final gesture detection modules employs t the forward algorithm to determine the distribution of the hidden states given new observations.

The Hidden Markov Model assumes knowledge of the state transition matrix which is the probability of the gesture transitioning from one state to each other state in one time step. Some embodiments, estimate this transition offline. Other embodiments assume that non-transitions are the most probable and allow the use of a single non-transition probability to be used as a parameter, while the transition probabilities are assumed to be equally likely. For example, a system with a non-transition probability of 0.99 assumes that the system with remain in the same state 99 frames out of 100 and that the 1% chance of transitioning is distributed equally among the other states.

In one embodiment the final gesture determination module operates according to the following algorithm which is embodied as instructions and stored in a memory and executed by at least one processor. The final gesture determination module includes an initialization portion which is performed at an initial state to enable the final gesture determination module to improve the determination that a gesture determined by the inference model is the particularly gesture. This initialization stage initializes a current gesture state probability as all states equally likely. E.g. if there are n possible gestures, then each gesture has a probability of 1/n. This is illustrated in Equation 1 below where s is the probability of a particular gesture.

$$s = {[ \frac{1}{n} , … , \frac{1}{n} ]}^{T} \qquad ( 1 )$$

Thereafter, the probability of staying in the same gesture state from one observation to the next observation is set to p. The probability of changing to from a current gesture state to another gesture state to be equally likely for each other state is set to be (1−p)/(n−1). From this, a transition matrix shown in Equation 2 can be computed.

$$T = [ \begin{matrix}1 / n & ⋯ & ( 1 - p ) / ( n - 1 ) \\ ⋮ & ⋱ & ⋮ \\ ( 1 - p ) / ( n - 1 ) & ⋯ & 1 / n\end{matrix} ] \qquad ( 2 )$$

Upon generation of the transition matrix T for use in a particular system to predict that a particular gesture from among a set of gestures is being perform, the final gesture determination module includes an update stage which receives, as an input, the output from S204 representing the inference that a particular gesture is detected in the image frame. Thus, the algorithm obtains the gesture probability estimates (q) from the inference model show in Equation 3:

$$q = [ {q}_{1} , … , {q}_{n} ] \qquad ( 3 )$$

From this α, representing the probability of the current gesture being the actual gesture given all previous output from the inference model, is computed according to Equation 4

$$α = q ⊙ Ts \qquad ( 4 )$$

where ⊙ is the element by element multiply operator which allows for each element of the vector q to be multiplied by each element of the vector resulting matrix Ts. Thereafter, all elements of α are summed according to Equation 5:

$$\hat{α} = {\sum }_{i = 1}^{n} {α}_{i} \qquad ( 5 )$$

And the state, representing the probability of the individual gestures in a current state given previous output, is determined in Equation 6:

$$s = α / \hat{α} \qquad ( 6 )$$

The final determination gesture is determined to be the returned state element with the highest state score which provides an indication that gesture is being performed with a higher degree of reliability. More specifically, the ability to determine the state based on current and immediately previous state determinations improves the reliability that any inferred state is the actual state of the hand and that the hand is actually performing a gesture which can then be detected and used to control another computing system.

Above is exemplary hardware that represents an apparatus that performs the above hand gesture model creation and processing and that can be used in implementing the above described disclosure. The apparatus includes a CPU 401, a RAM 402, a ROM 403, an input unit 404, an external interface 405, and an output unit 406. The CPU 401 controls the apparatus by using a computer program (one or more series of stored instructions executable by the CPU 401) and data stored in the RAM 402 or ROM 403. Here, the apparatus may include one or more dedicated hardware or a graphics processing unit (GPU), which is different from the CPU 401, and the GPU or the dedicated hardware may perform a part of the processes by the CPU 401. As an example of the dedicated hardware, there are an application specific integrated circuit (ASIC), a field-programmable gate array (FPGA), and a digital signal processor (DSP), and the like. The RAM 402 temporarily stores the computer program or data read from the ROM 403, data supplied from outside via the external interface, and the like. The ROM 403 stores the computer program and data which do not need to be modified and which can control the base operation of the apparatus. The input unit is composed of, for example, a joystick, a jog dial, a touch panel, a keyboard, a mouse, or the like, and receives user's operation, and inputs various instructions to the CPU 401. The external interface communicates with external device such as PC, smartphone, camera and the like. The communication with the external devices may be performed by wire using a local area network (LAN) cable, a serial digital interface (SDI) cable, WIFI connection or the like, or may be performed wirelessly via an antenna. The output unit is composed of, for example, a display unit such as a display and a sound output unit such as a speaker, and displays a graphical user interface (GUI) and outputs a guiding sound so that the user can operate the apparatus as needed.

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. An apparatus that generates a hand model for use in training a gesture recognition model that recognizes a hand gesture in a video data stream, the apparatus comprising:
One or more memories storing instructions;
One or more processors that, upon execution of the instructions stored in memory, are configured to:
identify digit vectors of a hand captured in video data by a an image capture apparatus;
normalize each identified digit;
generate a feature matrix by determining a feature associated with each normalized identified digit with respect to each other normalized identified digit;
flatten the generated feature matrix into a feature vector representing a state of the hand skeleton;
train a machine learning model based on the flattened feature matrix.

2. The apparatus according to claim 1, wherein the machine learning model includes
an input layer that receives an input of the flattened generated feature matrix;
a first dense layer having a first predetermined number of nodes with a first weighted matrix and a first length bias;
a non-linear layer including a predetermined number of activation functions;
a second dense layer having a second predetermined number of nodes with a second weighted matrix and a second length bias; and
a non-linear softmax layer;
wherein, the non-linear softmax layer outputs a confidence score identifying that a hand position corresponding to a hand in the captured video data is performing a predetermined gesture.

3. The apparatus according to claim 1, wherein execution of the instructions further configures the one or more processors to generate the feature matrix by
determining a dot product of each identified digit with respect to all other identified digits to generate matrix feature information representative of the dot product of each normalized digit with itself;
modify the diagonal of the matrix feature information to generate an enhanced feature vector using a predetermined feature modifier.

4. The apparatus according to claim 3, wherein the feature modifier normalizes a length of a respective digit based on a reference digit length.

5. The apparatus according to claim 4, wherein the reference digit length includes one or more of a minimum digit length, a maximum digit length, a median digit length and mean digit length.

6. The apparatus according to claim 3, wherein the feature modifier calculates a mid-digit point distance relative to a predetermined joint reference point that is normalized by a reference digit.

7. The apparatus according to claim 3, wherein the feature modifier calculates an angle of a digit relative to a fixed vector in a predetermined direction to determine an orientation of a hand in the video data.

8. The apparatus according to claim 1, wherein execution of the instructions further configures the one or more processors to
receive video data from an image capture device; and
use the trained machine learning model to detect performance of a gesture in the received video data.

9. A method for generating a hand model for use in training a gesture recognition model that recognizes a hand gesture in a video data stream, the method comprising:
identifying, digit vectors of a hand captured in video data by a an image capture apparatus;
normalizing each identified digit;
generating a feature matrix by determining a feature associated with each normalized identified digit with respect to each other normalized identified digit;
flattening the generated feature matrix into a feature vector representing a state of the hand skeleton;
training a machine learning model based on the flattened feature matrix.

10. The method according to claim 9, wherein the machine learning model includes
an input layer that receives an input having a size equal to a size of the flattened generated feature matrix;
a first dense layer having a first predetermined number of nodes with a first weighted matrix and a first length bias;
a non-linear layer including a predetermined number of activation functions;
a second dense layer having a second predetermined number of nodes with a second weighted matrix and a second length bias; and
a non-linear softmax layer;
wherein, the method further comprises outputting, by the non-linear softmax layer a confidence score identifying that a hand position corresponding to a hand in the captured video data is performing a predetermined gesture.

11. The apparatus according to claim 9, wherein generating the feature matrix further comprises
determining a dot product of each identified digit with respect to all other identified digits to generate feature information representative of the dot product of each normalized digit with itself;
modifying the diagonal of the feature information to generate an enhanced feature vector using a predetermined feature modifier.

12. The method according to claim 11, wherein the feature modifier normalizes a length of a respective digit based on a reference digit length.

13. The method according to claim 12, wherein the reference digit length includes one or more of a minimum digit length, a maximum digit length, a median digit length and mean digit length.

14. The method according to claim 11, wherein the feature modifier calculates a mid-digit point distance relative to a predetermined joint reference point that is normalized by a reference digit.

15. The method according to claim 11, wherein the feature modifier calculates an angle of a digit relative to a fixed vector in a predetermined direction to determine an orientation of a hand in the video data.

16. The method according to claim 9, further comprises
receiving video data from an image capture device; and
using the trained machine learning model to detect performance of a gesture in the received video data.
